(19) United States
(12) Patent Application Publication
(10) Pub. No.: US 2016/0201359 A1
(43) Pub. Date: Jul. 14, 2016

(54) QUICK RELEASE SECURITY DEVICE

(71) Applicant: INVUE SECURITY PRODUCTS INC., Charlotte, NC (US)

(72) Inventors: David N. Berglund, Charlotte, NC (US); Christopher J. Fawcett, Charlotte, NC (US); James K. Sankey, Charlotte, NC (US); Brent E. Van Camp, Charlotte, NC (US)

(21) Appl. No.: 14/912,780

(22) PCT Filed: Aug. 20, 2014
(86) PCT No.: PCT/US14/51845

§ 371 Date: Feb. 18, 2016

Related U.S. Application Data
(60) Provisional application No. 61/869,094, filed on Aug. 23, 2013.
(60) Provisional application No. 62/017,344, filed on Jun. 26, 2014.

(51) Int. Cl. E05B 73/00

(52) U.S. Cl. CPC E05B 73/0017

(57) ABSTRACT

A security device for securing an item of merchandise from theft is provided. The security device includes a housing configured to be coupled to the item of merchandise and a quick-release lock mechanism operably engaged with the housing. The quick-release lock mechanism is operable to lock the item of merchandise within or to the housing in a locked configuration and to allow the item of merchandise to be removed from the housing in an unlocked configuration. The quick-release lock mechanism is configured to communicate with an electronic key for locking and/or unlocking thereof.

### CROSS REFERENCE TO RELATED APPLICATIONS

The present application claims the benefit of the filing dates of U.S. Provisional Application No. 61/869,094, filed on Aug. 23, 2013, and U.S. Provisional Application No. 62/017,344, filed on Jun. 26, 2014, the disclosures of which are incorporated herein by reference in their entities.

### BACKGROUND OF THE INVENTION

Embodiments of the present invention relate generally to security devices for protecting items of merchandise from theft, such as consumer electronics products.

It is common practice for retailers to provide demonstration models of relatively expensive consumer electronics products, such as handheld devices, tablets, and laptop computers, so that a potential purchaser may examine the product more closely and test the operation of its features. A working demonstration model, however, increases the possibility that the demonstration model, or a removable component thereof, such as a battery pack, battery, memory card, lens, etc., will be stolen or removed from the display area by an unauthorized person. As a result, demonstration models of consumer electronics products are typically protected by a security device that permits a potential purchaser to examine and operate the product, while reducing the likelihood that the demonstration model or a removable component of the product will be stolen or removed from the display area.

Certain consumer electronics products are more difficult to protect than others. For example, hand-held devices and tablets are relatively small and include removable components that are easily separated from one another. Furthermore, these devices have various sizes which make one-size-fits all security devices more difficult. In addition, some security devices are cumbersome and limit the ability of the consumer to fully appreciate the features of the product.

### BRIEF SUMMARY

Embodiments of the present invention are directed to security devices and methods for securing an item of merchandise from theft. In one embodiment, a security device includes a housing configured to be coupled to the item of merchandise and a quick-release lock mechanism operably engaged with the housing. The quick-release lock mechanism is operable to lock the item of merchandise within or to the housing in a locked configuration and to allow the item of merchandise to be removed from the housing in an unlocked configuration. Moreover, the quick-release lock mechanism is configured to communicate with an electronic key for locking and/or unlocking thereof.

In another embodiment, a security device includes a bracket assembly comprising at least one arm configured to engage the item of merchandise and a housing operably engaged with the bracket assembly and configured to be secured to a display support. The security device further includes a quick-release lock mechanism operably engaged with the housing and the bracket assembly. The quick-release lock mechanism is operable to lock the item of merchandise to the housing with the at least one arm in a locked configuration and to allow the item of merchandise to be removed from the housing in an unlocked configuration. In addition, the quick-release lock mechanism is configured to communicate with an electronic key for locking and/or unlocking thereof.

In an embodiment of a method for securing an item of merchandise from theft, the method includes coupling at least one arm to the item of merchandise and locking the item of merchandise to a housing with a quick-release lock mechanism operably engaged with the housing and the at least one arm. The method also includes actuating the quick-release lock mechanism with an electronic key for locking and/or unlocking thereof.

### BRIEF DESCRIPTION OF THE DRAWINGS

The detailed description of the invention provided below may be better understood with reference to the accompanying drawing figures, which depict one or more embodiments of a security device and method.

FIG. 1 illustrates a top view of a security device according to one embodiment of the present invention.

FIG. 2 illustrates a side perspective view of the security device of FIG. 1.

FIG. 3 is an end view of the security device of FIG. 1.

FIG. 4 is a top view of the security device of FIG. 1 in an unlocked configuration.

FIG. 5 is an end view of the security device of FIG. 1 in an unlocked configuration.

FIG. 6 is a top view of the security device of FIG. 1 with the item of merchandise removed.

FIG. 7 is an enlarged view of a pusher of the security device of FIG. 1.

FIG. 8 is a top perspective view of the security device of FIG. 1 securing a different item of merchandise.

FIG. 9 illustrates a security device according to an embodiment of the present invention.

FIG. 10 illustrates a security device according to another embodiment of the present invention.

FIG. 11 illustrates a security device according to another embodiment of the present invention.

FIG. 12 is a perspective view of a security device according to one embodiment of the present invention.

FIG. 13 is a side view of the security device shown in FIG. 12.

FIG. 14 is an end view of the security device shown in FIG. 12.

FIG. 15 is a top view of the security device shown in FIG. 12 with the item of merchandise removed.

FIG. 16 is another perspective view of the security device shown in FIG. 12.

FIG. 17 is a perspective view of a security device according to another embodiment of the present invention.

FIG. 18 is an end view of the security device shown in FIG. 17.

FIG. 19 is a perspective view of the security device shown in FIG. 17 with the item of merchandise removed.

FIG. 20 is a perspective view of a security device according to another embodiment of the present invention.

FIG. 21 is a side view of the security device shown in FIG. 20.

FIG. 22 is an end view of the security device shown in FIG. 20.

FIG. 23 is a top view of the security device shown in FIG. 20 with the item of merchandise removed.

FIG. 24 is a partial perspective view of the security device shown in FIG. 20 with the item of merchandise removed.

FIG. 25 is another partial perspective view of the security device shown in FIG. 20.

FIG. 26 is a cross-sectional view of the security device of FIG. 20.

### DETAILED DESCRIPTION OF EMBODIMENTS OF THE INVENTION

Referring to the accompanying figures wherein identical reference numerals denote the same elements throughout the various views, embodiments of security devices and systems according to the present invention for protecting an item of merchandise against theft or unauthorized removal are illustrated. The item of merchandise 10 may be any item, including any number of consumer electronics products (e.g. hand-held device, cellular phone, smart phone, tablet, laptop computer, etc.). Embodiments of a security device, indicated generally at 20, 100, 200, are operable for securing the item of merchandise and permit a potential purchaser to examine and test the item of merchandise, while reducing the likelihood that the item of merchandise, or a removable component of the item of merchandise, will be stolen or removed from the display area by an unauthorized person. Although described in relation for use in a retail environment, the security devices 20, 100, 200 shown and described herein is suitable for engaging and securing an item of merchandise in a residential or commercial environment, and furthermore, is not intended to be limited to use only as a security display device for protecting against theft and/or unauthorized removal.

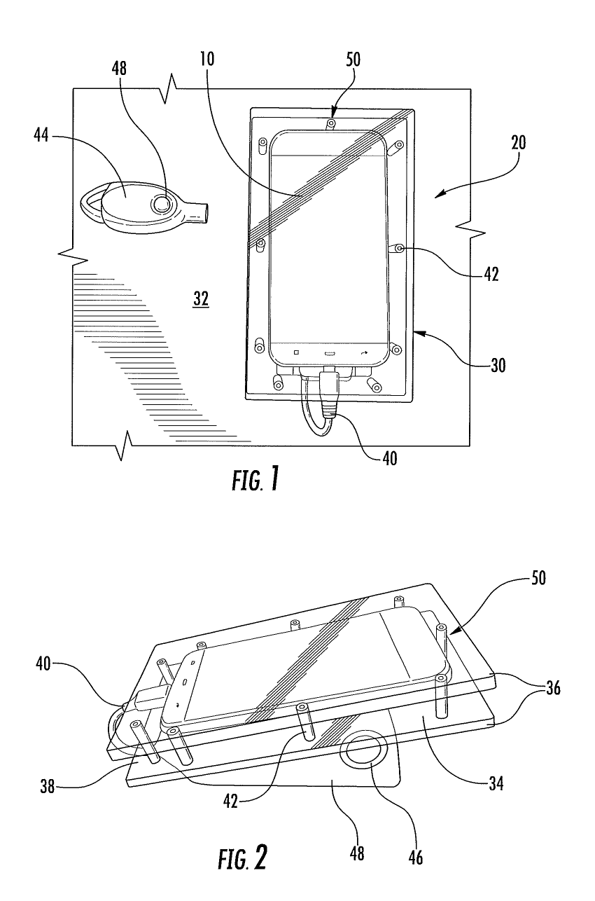

As shown in one embodiment according to FIGS. 1-8, the security device 20 comprises a housing 30. The housing 30 is configured to be coupled to the item of merchandise 10. For example, the housing 30 may be configured to fixed to a display surface 32, support, fixture, or the like, such as with adhesives and/or fasteners. In one embodiment, the housing 30 defines an enclosure 34 configured to at least partially enclose the item of merchandise 10. In the illustrated embodiment, the housing 30 includes a pair of plates 36 spaced apart from one another and configured to receive the item of merchandise 10 therein. Thus, an opening or space 38 may be defined at least partially about the perimeter of the housing 30. In the instance where the item of merchandise 10 includes first and second opposing major surfaces, the enclosure 34 is configured to cover at least the first and second opposing major surfaces. As shown in FIG. 2, the opening 38 defined between the plates 36 may allow a power cord and associated connector 40 to be inserted through the opening and into an input port on the item of merchandise 10 for providing power to the item. Because the opening 38 may extend about the perimeter of the enclosure 34, power cords and associated connectors can be inserted in a variety of locations to accommodate power input ports at different locations on the item of merchandise 10. The plates 36 may be secured together using a variety of techniques, such as pins, fasteners, or the like. FIG. 1 shows that a plurality of pins 42 may be spaced about the perimeter of the housing 30 and used to secure the plates 36 together. In other embodiments, the housing 30 may be a container that is configured to completely enclose the item of merchandise 10. Thus, the housing 30 could include a container body defining an enclosure with an open end or surface. The open end or surface of the enclosure could be left open or could include a lid connected to the container body. The housing 30 may be formed using any desirable material, such as polymeric material. As shown in FIG. 1, the housing 30 may include a clear polymeric material such that the item of merchandise 10 may be viewed through the housing.

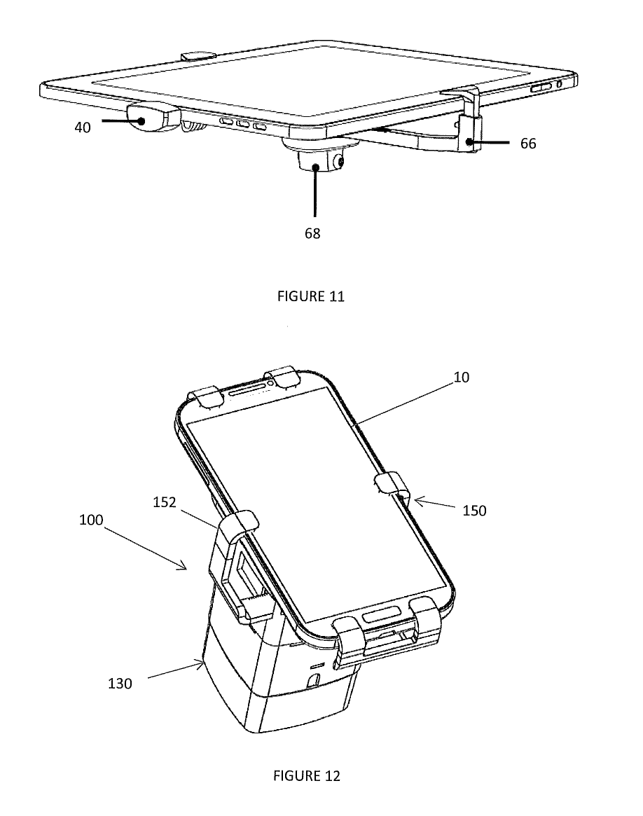

It is understood that the housing 30 may take on many different configurations and include various alternative features. For example, the housing 30 may include a sensor 68 configured to detect unauthorized detachment of the item of merchandise 10 from the housing and/or unauthorized removal of the item of merchandise from the sensor (see, e.g., FIG. 11). The sensor 68 may be fixed to the item of merchandise 10 using an adhesive or any other suitable technique. Should the sensor 68 be removed without being disarmed, the sensor may be configured to detect the unauthorized removal (e.g., via a pressure switch) and facilitate generation of a security signal (e.g., an audible, visible, and/or haptic signal). For example, the security device 20 may include an alarm in communication with the sensor 68 and be configured to generate a security signal in response to unauthorized removal of the item of merchandise 10 from the housing 30. Other optional features of the security device 20 include a tether coupled to the housing 30. The tether may be used to mechanically secure the housing 30 to a display surface 32. The tether may be further coupled to a recoiler for allowing the length of the tether to be adjusted relative to a base 48. In addition, the tether could be utilized to transfer power to the item of merchandise 10. For example, an external power source or an internal power source within the housing 30 may transmit power through the tether, and a power cord engaged with an input port on the item of merchandise 10 may be electrically coupled to the tether. Likewise, a power cord may be connected directly between the housing 30 or an external power source and the input port of the item of merchandise 10 for providing power thereto.

In other embodiments, the housing 30 comprises a bracket assembly 64 configured to releasably engage the item of merchandise 10 (see, e.g., FIG. 10). In this regard, the bracket assembly 64 may include one or more arms 66 configured to engage the item of merchandise 10. The arms 66 may be adjustable with respect to the item of merchandise 10 so that various sized items may be accommodated. The arms 66 could be adjusted in a lateral direction with respect to the item of merchandise 10 to account for items having various lengths and widths and/or adjusted vertically to account for items having various thicknesses. It is understood that the arms 66 may be various sizes and configurations depending the size and shape of the item of merchandise 10 and level of security desired.

In one embodiment, the security device 20 may include an arming/disarming device, such as a key 44. In one embodiment, the key 44 is electronic and is configured to communicate with a quick-release lock mechanism 50 for locking/unlocking the lock mechanism using a unique identifying code, which is described in greater detail below. As shown in FIG. 2, a transfer port 46 is provided on, or coupled to, the housing 30 that is configured to communicate with the key 44. FIG. 2 shows that the transfer port 46 may be operably engaged with a base 48, and the housing 30 is mounted onto the base. However, it is understood that the transfer port 46 may be located at any desirable location, including on the housing 30 itself, or remotely therefrom. The transfer port 46 may be configured to wirelessly communicate with the key 44 containing a security code. In one embodiment, the key 44 is similar to that described in U.S. Pat. No. 7,737,845 and U.S. Patent Publication No. 2012/0047972, each of which is hereby incorporated by reference in its entirety herein.

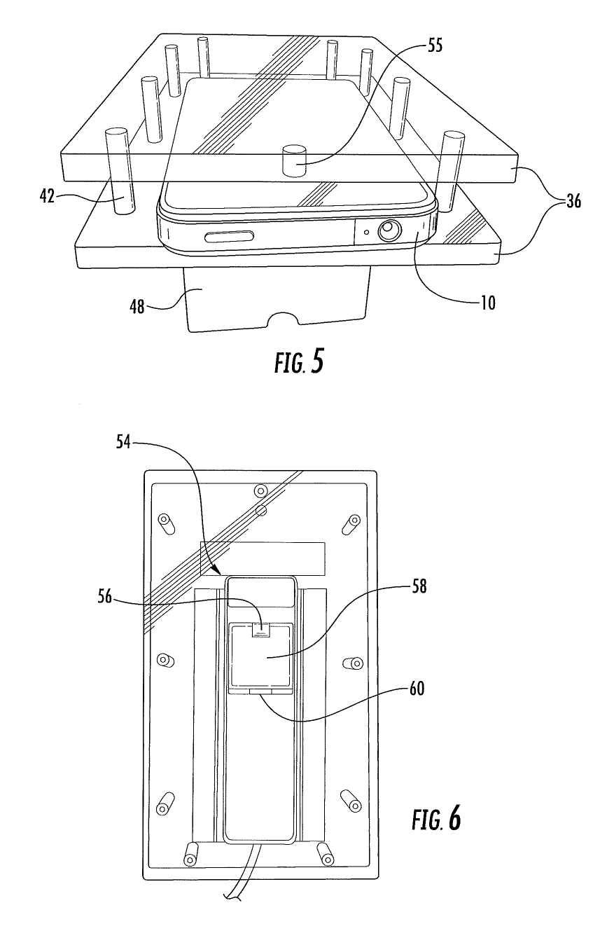

The security device 20 may also include a quick-release lock mechanism 50. The quick-release lock mechanism 50 may be operably engaged with the housing 30 and is configured to lock and/or unlock the item of merchandise 10 to or within the housing. The quick-release lock mechanism 50 is operable to lock the item of merchandise 10 within or to the housing 30 in a locked configuration (see, e.g., FIGS. 1-3) and to allow the item of merchandise to be removed from the housing in an unlocked configuration (see, e.g., FIGS. 4 and 5). In one embodiment, the item of merchandise 10 is configured to be automatically removed at least partially from the housing 30 when the quick-release lock mechanism 50 is actuated to the unlocked configuration. Thus, when the quick-release lock mechanism 50 is actuated, the item of merchandise 10 may be partially extended out of the housing 30 so that a consumer or associate may readily remove the item from the housing. In some cases, it may not be desirable to at least partially remove the item of merchandise 10 from the housing 30 automatically. In this instance, when the quick-release lock mechanism 50 is unlocked, the associate may simply remove the item of merchandise 10 manually from the housing 30. In addition, when removed from the housing 30, the item of merchandise 10 may be readily handled by the consumer without any sensors, brackets, etc. attached to the item. Therefore, the consumer is able to handle the item of merchandise 10 without any impediments. To counter theft, a retail establishment may require an associate to unlock the quick-release lock mechanism 50 and accompany the consumer while the consumer examines the item of merchandise 10. When the consumer is finished examining the item of merchandise 10, the associate may then place the item in or on the housing 30 and re-secure the quick-release lock mechanism 50.

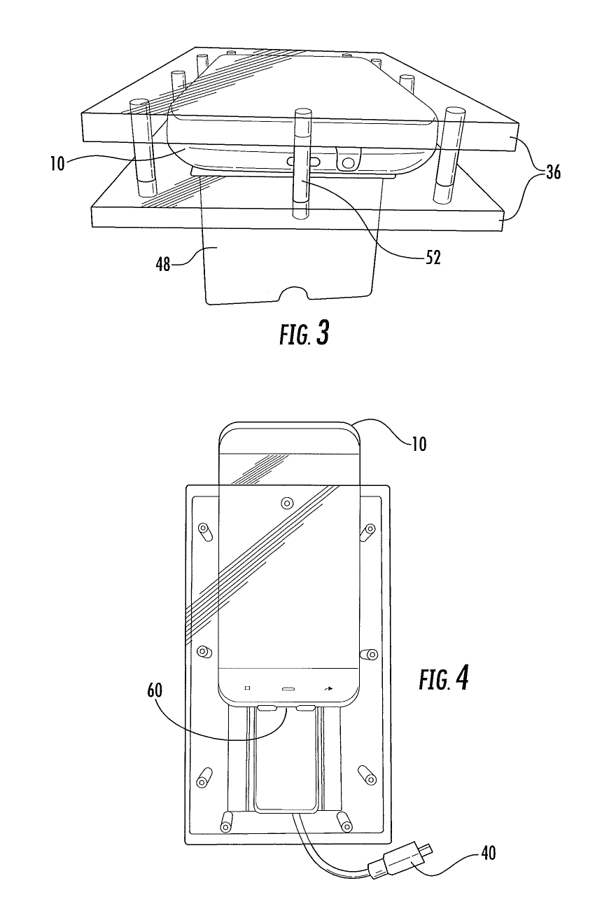

The quick-release lock mechanism 50 may be any suitable mechanism configured to lock the item of merchandise 10 to or in the housing 30. For example, FIG. 3 shows that a pin 52 may be removably engaged with the housing 30. The pin 52 may be actuated in response to communication between the key 44 and the transfer port 46. Thus, when the key 44 is placed in proximity to, or in engagement with, the transfer port 46, the key is configured to actuate the quick-release lock mechanism 50 such that the pin 52 is removed from the housing 30, thereby allowing the item of merchandise 10 to be removed (see, e.g., FIG. 4). The pin 52 may be configured to move linearly between the locked and unlocked configurations. In one embodiment shown in FIG. 5, the pin 52 may be configured to removably engage an opening 55 defined in one or both of the plates 36. Thus, when the pin 52 is engaged within the opening 55, the item of merchandise 10 cannot be removed from the housing 30, and when the pin is removed from the opening, the item can be removed.

It is understood that various quick-release locking mechanisms 50 could be utilized to secure the item of merchandise 10 to or in the housing 30, including various mechanical and/or electrical mechanisms. In addition, although an electronic key 44 has been discussed herein, it is understood that other mechanisms may be used to actuate the quick-release lock mechanism 50, including mechanical keys, magnetics, passwords, NFC communication, biometrics, and the like. Furthermore, the quick-release lock mechanism 50 may be actuated to the locked configuration and/or the unlocked configuration. Namely, the quick-release lock mechanism 50 would typically be actuatable from the locked configuration to the unlocked configuration, such as with a key 44 as described above. In some embodiments, the quick-release lock mechanism 50 may also be configured to be actuated to the locked configuration (e.g., using a key 44). However, the quick-release lock mechanism 50 could alternatively be configured to automatically lock when positioned within the housing 30 such that actuation with a key 44 or other manual intervention is unnecessary to lock the item of merchandise 10 to or within the housing 30.

In one embodiment, the quick-release lock mechanism 50 comprises a shape-memory material and is responsive to electrical power to facilitate unlocking of the lock mechanism. Thus, the key 44 may be configured to transfer power to the security device 20 to operate the quick-release lock mechanism 50. In one embodiment, electrical contacts disposed on the electronic key 44 electrically couple with cooperating electrical contacts on the transfer port 46 to transfer power from the internal battery of the key to the quick-release lock mechanism 50. In other embodiments, the power transfer may occur using inductance. Power may be transferred directly to the quick-release lock mechanism 50 via one or more conductors. For example, a conductor may be coupled to a mechanical quick-release lock mechanism 50, and when electrical power is conducted through the conductor, a state change occurs thereby resulting in operation of the lock mechanism. In one example, the conductor is coupled to a shape memory material (e.g., Nitinol) such that electrical power transferred through the conductor results in a change in shape of the shape memory material (e.g., contraction). Such a change in shape may cause a mechanical actuation (e.g., linear or rotary) of the quick-release lock mechanism 50 to thereby lock or unlock the lock mechanism. In some embodiments, the quick-release latch mechanism 160 may utilize a shape memory material as disclosed in U.S. application Ser. No. 14/328,051, filed on Jul. 10, 2014, the disclosure of which is incorporated herein by reference in its entirety. In other embodiments, the quick-release lock mechanism 50 may cooperate with a motor or solenoid for operating the lock mechanism.

Furthermore, the quick-release lock mechanism 50 could be utilized to actuate the housing 30 itself to facilitate removal of the item of merchandise 10. For example, the housing 30 could be opened when the quick-release lock mechanism 50 is actuated allowing the item of merchandise 10 to be removed. Thus, where the housing 30 includes a lid or other removable portion, the lid could be automatically opened when the quick-release lock mechanism 50 is actuated.

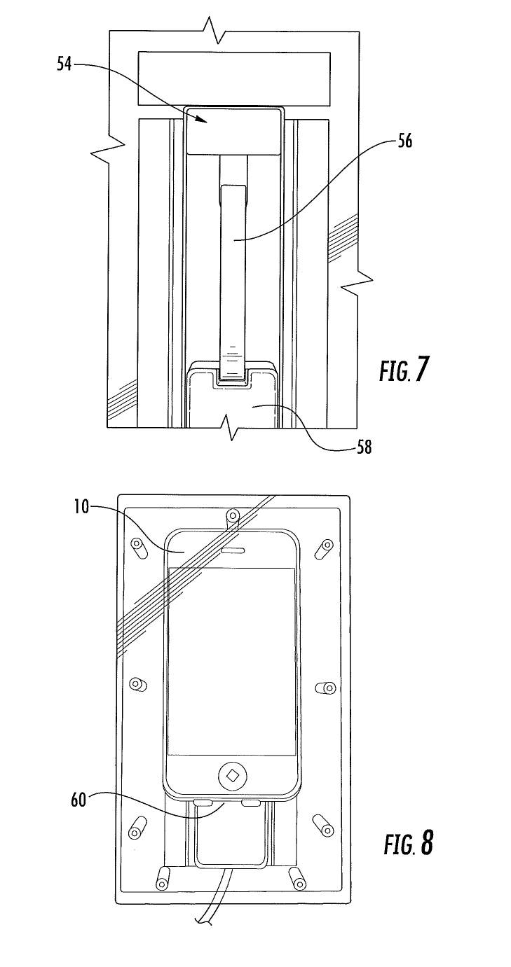

To facilitate removal of the item of merchandise from the housing 30, the security device 20 may further include a pusher 54 operably engaged with the housing and configured to displace the item of merchandise 10 at least partially from the housing when the quick-release lock mechanism 50 is actuated to the unlocked configuration (see, e.g., FIG. 6). In one example, the pusher 54 is spring loaded. For instance, FIGS. 6 and 7 illustrate a spring 56 that could be utilized, wherein the spring is extendable and is biased towards the retracted position shown in FIG. 6. The spring 56 may be any suitable spring, such as a coil or compression spring. The pusher 54 may be coupled to a support member 58 that is configured to support or otherwise engage a surface of the item of merchandise 10. FIG. 6 shows that the support member is 58 configured to engage a bottom end of the item of merchandise 10 and may also include an opening 60 for receiving a power cord and connector 40. In one embodiment, the support member 58 is generally L-shaped and includes a ledge for engaging an end of the item of merchandise 10. The support member 58 may be operably engaged with a slot defined in the housing and may be configured to travel along the slot between the locked and unlocked configurations. Moreover, other actuators may be utilized to facilitate removal of the item of merchandise 10 from the housing 30, such as mechanical and/or electrical mechanisms. Although the illustrated embodiment illustrates that the pusher 54 is configured to partially displace the item of merchandise 10 upwardly out of the housing 30, it is understood that the pusher could be configured to displace the item of merchandise in any desired direction relative to the housing.

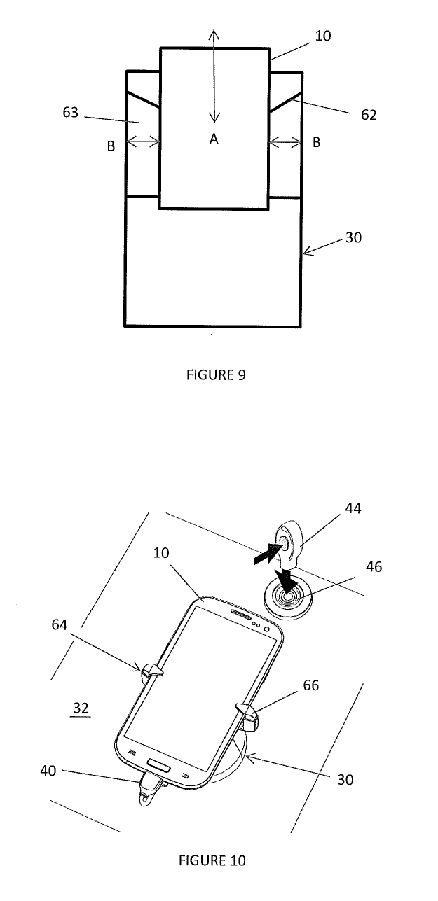

In one embodiment, the security device 20 also includes an alignment mechanism 62 configured to align the item of merchandise relative to the housing (see, e.g., FIG. 9). For example, the alignment mechanism 62 may be configured to releasably engage opposed sides of the item of merchandise 10. In one example, the alignment mechanism 62 is spring loaded such that the alignment mechanism is urged into engagement with the item of merchandise 10. The alignment mechanism 62 may include one or more arms or rails 63 on opposing sides of the item of merchandise 10. Moreover, the alignment mechanism 62 may include a tapered or funneled shape at an end for receiving the item of merchandise 10 such that as the item is pushed into engagement with the alignment mechanism 62 (along direction “A”), the arms 63 are pushed away from one another while being biased into engagement with the item of merchandise (along direction “B”). As such, the item of merchandise 10 may be centered between the arms 63. Thus, the alignment mechanism 62 may be used to accommodate items of merchandise 10 having different widths (see, e.g., FIGS. 1 and 8).

In another embodiment, the quick-release lock mechanism 50 is operably engaged with a bracket assembly 64 and is configured to release the bracket assembly from a locked configuration (see, e.g., FIG. 10). As discussed above, the bracket assembly 64 may include one or more arms 66 configured to releasably engage the item of merchandise 10. At least one of the arms 66 may be configured to be unlocked via a quick-release lock mechanism 50. For instance, where a plurality of arms 66 are employed, one of the arms may be disengaged via actuation of the quick-release lock mechanism 50 to allow the item of merchandise 10 to be removed from the housing 30. For example, a key 44 may communicate with a transfer port 46 that is operably engaged with the quick-release lock mechanism 50 and is configured to actuate the quick-release lock mechanism, which in turn disengages at least one of the arms 66 from the item of merchandise 10. The arm 66 that is disengaged may be biased away from the item of merchandise 10 such that unlocking of the arm causes the arm to automatically release the arm from the item of merchandise. The quick-release lock mechanism 50 could be similar to that described above, utilizing mechanical and/or electrical means for locking the bracket assembly 64 in position relative to the item of merchandise 10 (e.g., a movable pin 52) and unlocking the bracket assembly. The item of merchandise 10 could be automatically removed from the housing 30 in the unlocked configuration. Alternatively, the arm 66 may be disengaged from the housing 30 to simply allow access to the item of merchandise 10 for authorized removal thereof.

In another embodiment, the bracket assembly 64 may remain attached to the item of merchandise 10 in the unlocked configuration. In this regard, the item of merchandise 10 and the bracket assembly 64 may be removably secured to the housing 30. As discussed above, the item of merchandise 10 and bracket assembly 64 may be locked to the housing 30 in a locked configuration. When in the unlocked configuration, the item of merchandise 10 along with the bracket assembly 64 may be removed from the housing 30. When removed from the housing 30, the item of merchandise 10 and bracket assembly 64 would be tetherless and able to be examined by a consumer. FIG. 11 shows an example where an item of merchandise 10, with arms 66 operably engaged therewith, is in an unlocked configuration relative to the housing 30. FIG. 11 also shows that a sensor 68 may be secured to the item of merchandise 10, which as discussed above, may be operable to determine unauthorized removal of the sensor from the item of merchandise. The quick-release lock mechanism 50 could be configured to engage the sensor 68 in the locked configuration using any suitable mechanical and/or electrical means, similar to that described above. For example, one or more actuatable pins 52 may be configured to extend and retract relative to the sensor 68 to thereby engage and disengage the sensor in response to communication with an authorized key.

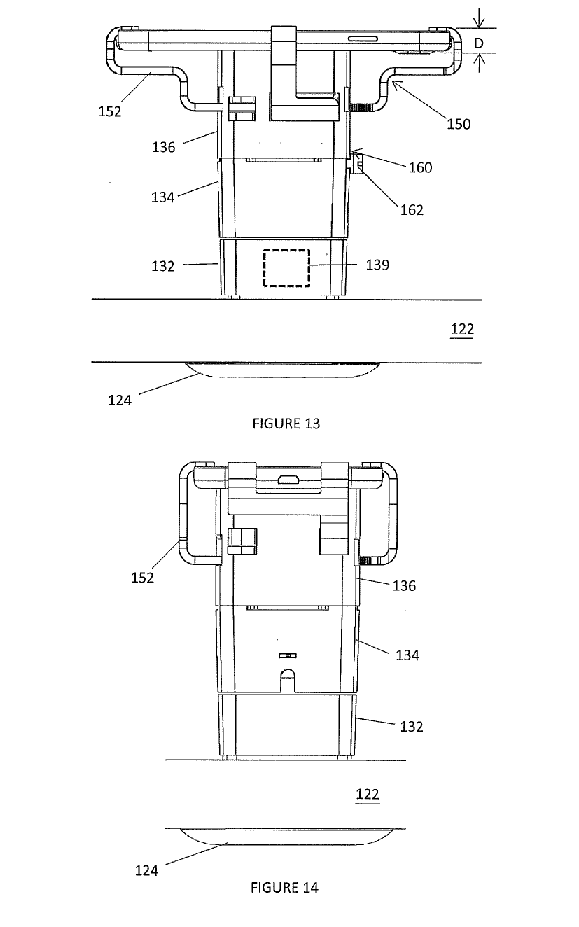

According to another embodiment shown FIGS. 12-16, a security device 100 comprises a housing 130. The housing 130 is configured to be coupled to the item of merchandise and/or to a display surface 122. For example, the housing 130 may be configured to be fixed to the item of merchandise 10 with a bracket assembly 150 as described in further detail below. The housing may also be secured to a display surface 122, support, fixture, or the like, such as with adhesives and/or fasteners. For example, FIG. 13 shows the housing 130 secured to a display support 122 with a fastener 124. The fastener 124 may be configured to threadably engage the housing 130 such that the display support 122 is positioned between the bottom of the housing and the fastener 124 below the display support. The fastener 124 may include a post that extends through the display surface and is threadably engageable with the housing 130. The housing 130 may be additionally secured to the display surface 122 with an adhesive if desired.

It is understood that the housing 130 may take on many different configurations and include various alternative features. For example, the housing 130 may include one or more components operably engaged with one another. FIGS. 13, 14, and 18 show that the housing 130 includes a lower portion 132 configured to be secured to a display surface, a medial portion 134, and an upper portion 136. The lower 132, medial 134, and upper 136 portions may be separate components assembled together. In one embodiment, the medial 134 and upper 136 portions are pre-assembled together and are later secured to the lower portion 132 during installation of the security device. In some cases, the upper 136 and medial 134 portions are secured to the lower portion 132 with one or more fasteners accessed through fastener holes in the top surface of the upper portion. In some instances as shown in FIG. 16, the medial portion 134 and the lower portion 132 may be configured to pivot relative to one another. For instance, the lower portion 132 may include a swivel assembly that allows the medial 134 and upper 136 portions to pivot relative to the lower portion. Thus, the item of merchandise 10 may be pivotable to different orientations while secured to the housing 130. Moreover, the lower portion 132 is shown as having a substantially flat top surface. However, it is understood that the top surface of the lower portion 132 may be angled in some embodiments. In other embodiments, one or more portions of the housing 130 is formed of metal. For example, the upper portion 136, arms 152, and/or internal gearing may be formed of metal, while various other external or ornamental portions may be formed of a polymeric material

Furthermore, the housing 130 may include a sensor 138 configured to detect unauthorized detachment of the item of merchandise 10 from the housing and/or unauthorized removal of the item of merchandise from the sensor. The sensor 138 may be configured to engage the item of merchandise 10 when the merchandise is secured to the housing 130 with the bracket assembly 150. The sensor 138 may be in communication with an alarm 139 (see, e.g., FIG. 13). Should the item of merchandise 10 be removed without first disarming the alarm, the sensor 138 may be configured to detect the unauthorized removal. In one embodiment, the sensor 138 is a pressure or plunger switch. The sensor 138 may be configured to communicate with the alarm to facilitate generation of a security signal with the alarm (e.g., an audible, visible, and/or haptic signal). For example, the housing 130 may house an alarm in communication with the sensor 138 that is configured to generate a security signal in response to unauthorized removal of the item of merchandise 10 from the housing. Other optional features of the security device include a battery that is configured to provide power for security, including actuating the alarm and/or any monitoring electronics. The housing 130 may include a printed circuit board that is electrically connected to the alarm, battery, and/or the sensor 138. In addition, a power cord and connector 40 could be utilized to transfer power to the item of merchandise 10. For example, an external power source or an internal power source within the housing 130 may transmit power through the power cord and connector 40 engaged with an input port on the item of merchandise 10. In some embodiments, an external power source may provide power directly to the housing 130, and the housing may pass power to the item of merchandise 10. Thus, a power cord may be electrically connected to the housing 130 and be configured to plug into the item of merchandise 10. The housing 130 may also include voltage regulation circuitry in cases where power is provided to the item of merchandise 10 from the housing. Alternatively, an external power cord may be routed through an opening in the fastener 124 and through the support surface 122 to be plugged into the item of merchandise 10.

In other embodiments, the housing 130 comprises a bracket assembly 150 configured to releasably engage the item of merchandise 10. In this regard, the bracket assembly 150 may include one or more arms 152 configured to engage the item of merchandise 10. The arms 152 may be adjustable with respect to the item of merchandise 10 so that various sized items may be accommodated. The arms 152 could be adjusted in a lateral direction (e.g., in a X or Y-direction) with respect to the item of merchandise 10 to account for items having various lengths and widths and/or adjusted vertically (e.g., in a Z-direction) to account for items having various thicknesses. Furthermore, the arms 152 may be interchangeable with arms of various sizes for accommodating different sized items of merchandise 10. As will be understood, the arms 152 may be any desired shape and configuration for engaging and securing an item of merchandise 10. In this particular embodiment, four arms 152 are shown, although any number of arms may be used in other embodiments. Moreover, the arms 152 may be insertable within openings defined in the housing 130 such that the arms may be adjusted laterally relative thereto. In some embodiments described in greater detail below, the openings in the housing 130 may also allow the arms 152 to move upwardly and downwardly relative to the housing. The arms 152 may have any desired shape that secures the item of merchandise 10 to the housing 130. In one example, the ends of the arms 152 have a C-shape for extending around the lateral edges of the item of merchandise 10. Thus, when secured by the arms 152 in a locked configuration, the item of merchandise 10 cannot be removed without first unlocking the arms.

At least one of the arms 152 may be configured to be unlocked via a quick-release lock mechanism 160 as described in further detail below. As used herein, “quick release” may refer to actuation that allows the item of merchandise 10 to be readily removed from the security device 100 without the need to first remove one or more fasteners or otherwise disassemble the security device. For instance, where a plurality of arms 152 are employed, at least one of the arms may be disengaged via actuation of the quick-release lock mechanism 160 to allow the item of merchandise 10 to be readily removed from the housing 130. For example, a key 44 may communicate with a transfer port 146 that is operably engaged with the quick-release lock mechanism 160 and is configured to actuate the quick-release lock mechanism, which may in turn disengage at least one of the arms 152 from the item of merchandise 10. The arm(s) 152 that is disengaged may be biased or moved away from the item of merchandise 10 such that unlocking of the arm causes the arm to automatically release the arm from the item of merchandise. The item of merchandise 10 could be automatically removed from the housing 130 in the unlocked configuration (e.g., via biasing of a spring or the like). Alternatively, the arm 152 may be disengaged from the housing 130 to simply allow access to the item of merchandise 10 for authorized removal thereof.

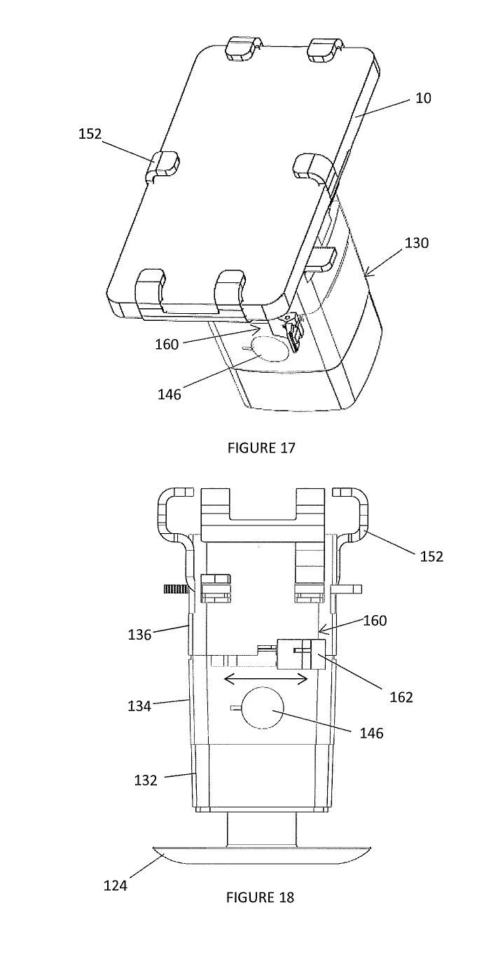

In one embodiment, the security device 100 may include a locking/unlocking and/or an arming/disarming device, such as a key 44, as discussed above. In one embodiment, the key 44 is electronic and is configured to communicate with the quick-release lock mechanism 160 for locking/unlocking the lock mechanism, which is described in greater detail below. The key 44 may also be configured to arm and/or disarm the alarm or other monitoring electronics. The key 44 may be configured to unlock the quick-release lock mechanism 160 and disarm the alarm simultaneously in some embodiments. As shown in FIG. 17, a transfer port 146 is provided on, or coupled to, the housing 130 that is configured to communicate with the key 44. FIG. 17 shows that the transfer port 146 may be operably engaged with the medial portion 134. However, it is understood that the transfer port 146 may be located at any desirable location on the housing 130. The transfer port 146 may be configured to wirelessly communicate with the key 44 such as in response to actuating an actuator 48 on the key. In some cases, the key 44 contains a security code, and the security device may be programmed with the same security code.

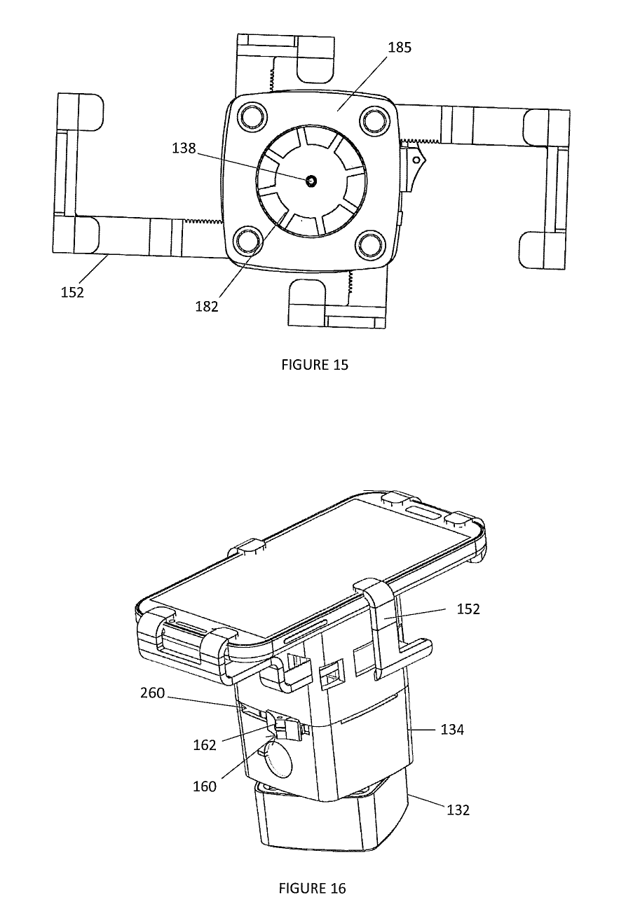

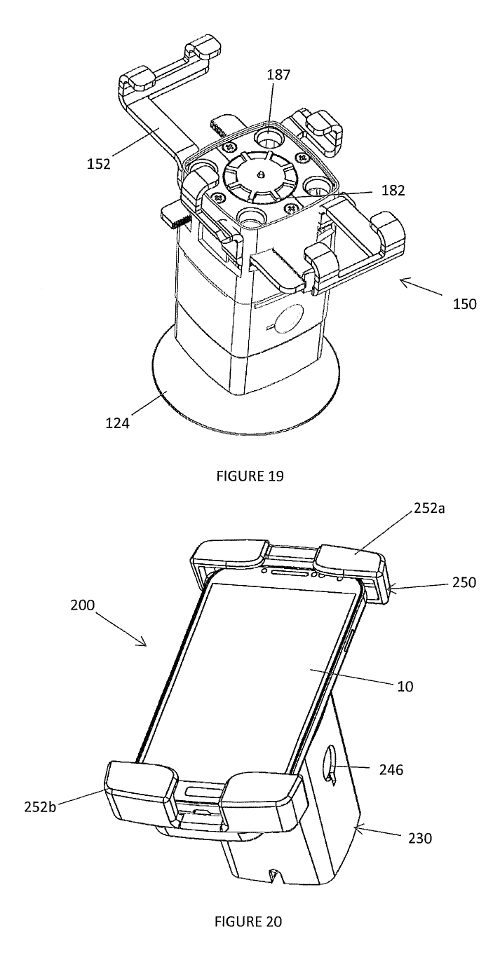

As noted above, the security device 100 may also include a quick-release lock mechanism 160. The quick-release lock mechanism 160 may be operably engaged with the housing 130 and/or the bracket assembly 150 and is configured to lock and/or unlock the item of merchandise 10 to the housing and/or bracket assembly. The quick-release lock mechanism 160 is operable to lock the item of merchandise 10 to the housing 130 in a locked configuration (see, e.g., FIGS. 12-14) and to allow the item of merchandise to be removed from the housing and/or bracket assembly 150 in an unlocked configuration (see, e.g., FIGS. 15 and 19). In one embodiment, when the quick-release lock mechanism 160 is unlocked, the associate may simply remove the item of merchandise 10 manually from the housing 130 and/or bracket assembly 150. In addition, when removed from the housing 130 and/or bracket assembly 150, the item of merchandise 10 may be readily handled by the consumer without any sensors, brackets, etc. attached to the item. Therefore, the consumer is able to handle the item of merchandise 10 without any impediments. To counter theft, a retail establishment may require an associate to unlock the quick-release lock mechanism 160 and accompany the consumer while the consumer examines the item of merchandise 10. When the consumer is finished examining the item of merchandise 10, the associate may then place the item in or on the housing 130 and/or bracket assembly 150 and re-secure the quick-release lock mechanism 160.

The quick-release lock mechanism 160 may be any suitable mechanism configured to lock the item of merchandise 10 to the housing 130. In one embodiment, an actuator 162 is operably engaged with a latch mechanism disposed within the housing 130. The latch mechanism may be operably engaged with a shape memory material (e.g., a Nitinol wire) which is in electrical communication with the transfer port 146. The latch mechanism may be configured to engage a slot or opening defined in the actuator 162 which secures the latch in a locked position. The latch mechanism may be actuated in response to communication between the key 44 and the transfer port 146. Thus, when the key 44 is placed in proximity to, or in engagement with, the transfer port 146, the key is configured to actuate the latch mechanism such that the latch mechanism disengages the actuator 162.

Therefore, in one embodiment, the quick-release lock mechanism 160 comprises a shape-memory material and is responsive to electrical power to facilitate unlocking of the lock mechanism. Thus, the key 44 may be configured to transfer power to the security device 100 to operate the quick-release lock mechanism 160. In one embodiment, electrical contacts disposed on the electronic key 44 electrically couple with cooperating electrical contacts on the transfer port 146 to transfer power from the internal battery of the key to the quick-release lock mechanism 160. In other embodiments, the power transfer may occur using inductance. Power may be transferred directly to the quick-release lock mechanism 160 via one or more conductors. For example, a conductor may be coupled to a mechanical quick-release lock mechanism 160, and when electrical power is conducted through the conductor, a state change occurs thereby resulting in operation of the lock mechanism. In one example, the conductor is coupled to a shape memory material such that electrical power transferred through the conductor results in a change in shape of the shape memory material (e.g., contraction). Such a change in shape may cause a mechanical actuation (e.g., linear and/or rotary) of the quick-release latch mechanism 160 to thereby lock or unlock the latch mechanism.

It is understood that various quick-release locking mechanisms 160 could be utilized to secure the item of merchandise 10 to the housing 130 and/or bracket assembly 150. The quick-release lock mechanism 160 may utilize various mechanical and/or electrical means for locking the bracket assembly 150 in position relative to the item of merchandise 10 and unlocking the bracket assembly. In one embodiment, a solenoid or motor may be implemented for actuating the quick-release lock mechanism 160. The solenoid or motor could be used to actuate the quick-release lock mechanism 160 between locked and unlocked positions.

In addition, although an electronic key 44 has been discussed herein, it is understood that other mechanisms may be used to actuate the quick-release lock mechanism 160, including mechanical keys, magnetics, passwords, NFC communication, and the like. Furthermore, the quick-release lock mechanism 160 may be actuated to the locked configuration and/or the unlocked configuration. Namely, the quick-release lock mechanism 160 would typically be actuatable from the locked configuration to the unlocked configuration, such as with a key 44 as described above. In some embodiments, the quick-release lock mechanism 160 may also be configured to be actuated to the locked configuration (e.g., using a key 44). However, the quick-release lock mechanism 160 could alternatively be configured to automatically lock when the item of merchandise 10 is positioned within or in engagement with the housing 130 such that actuation with a key 44 or other manual intervention is unnecessary to lock the item of merchandise 10 to the housing 130.

In some embodiments, disengagement of the latch mechanism allows the actuator 162 to be moved relative to the housing 130 for disengaging the arms 152 from the merchandise 10, repositioning/replacing the arms, or relocking the lock mechanism 160. Thus, the actuator 162 may be manually actuated following disengagement of the latch mechanism 160. Upon disengagement of the actuator 162 from the latch mechanism, the actuator may be biased to a disengaged position. For instance, the actuator 162 may be biased downwardly, and in this position, may be moved for performing one or more functions. The actuator 162 may be configured to be moved linearly along an opening or slot defined in the housing 130 to different positions. In one example, movement of the actuator 162 in one direction (e.g., to the right with reference to FIG. 18) disengages one or more arms 152 from the item of merchandise 10. Thus, movement of the actuator 162 may in turn move the arms a sufficient distance to allow the item of merchandise 10 to be removed from the housing 130 and the bracket assembly 150. Movement of the actuator 162 in an opposite direction (e.g., to the left with reference to FIG. 18) allows the arms 152 to be removed or adjusted to a desired position. The actuator 162 may also be moved to actuate the lock mechanism 160 to a locked configuration.

To facilitate placement of the item of merchandise 10 relative to the housing 130 and the bracket assembly 150, a riser plate 182 may be provided (see, e.g., FIG. 19). In this regard, the riser plate 182 may be configured to adjust the arms 152 upwardly and downwardly or in a vertical direction relative to the top surface of the housing 130 (e.g., in a Z-direction). In some cases, the riser plate 182 is operably engaged with the bracket assembly 150 such that movement of the riser plate moves the bracket assembly. The riser plate 182 may be rotatable relative to the housing 130 such that rotation in one direction reduces the distance or height “D” between the ends of the arms 152 and the top surface of the housing 130 (see, e.g., FIG. 13) and rotation in an opposite direction increases the distance or height between the ends of the arms and the top surface of the housing. In one example, the riser plate 182 is threadably engaged with the bracket assembly 150 for adjusting the distance between the ends of the arms 152 and the top surface of the housing 130. As such, the riser plate 182 is able to accommodate items of merchandise 10 having different thicknesses. The configuration of the riser plate 182 and the bracket assembly 150 provides additional security in that the riser plate cannot be easily manipulated or tampered with, which reduces the ability to remove the item of merchandise 10 in an unauthorized manner. In addition, the riser plate 182 provides a mechanism for easily adjusting the distance between the arms 152 and the housing 130. In some cases, the riser plate 182 may include one or more indicators that identify particular thicknesses of items of merchandise 10 so that the user can easily adjust the riser plate.

In order to assemble a security device according to one embodiment, a hole is formed in the display support 122, and the fastener 124 is positioned through the hole such that a threaded portion extends out of the hole for access on a top surface of the display support. The housing 130 may then be positioned over the fastener 124 such that the fastener extends within the housing. The housing 130 may be threadably secured to the fastener 124 to secure the housing relative to the display support 122. The arms 152 may then be inserted within the openings defined in the upper portion 136 and adjusted laterally to engage the item of merchandise 10. The riser plate 182 may be adjusted to fit the proper thickness of the item of merchandise 10. A back plate 185 may be secured to a rear surface of the item of merchandise 10, such as with an adhesive (see, e.g., FIG. 15). The back plate 185 may include one or more protrusions that are configured to mate with and nest in the fastener openings 187 defined on the top surface of the upper portion 136. Once the adjustment of the arms 152 and the riser plate 182 is finalized, the actuator 162 may be actuated to a locked position. In the locked position, the alarm may be automatically armed, in response to communication with a key 44, or in response to engagement of the sensor 138 with the item of merchandise 10. It is understood that the aforementioned method of assembly was provided for illustration only and that various other steps may be provided and that the steps may be performed in any desired order.

FIGS. 20-26 illustrate another embodiment of a security device. Similar to the embodiments discussed above, the security device 200 includes a housing 230, a bracket assembly 250, and a quick-release lock mechanism 260. As also discussed above, the housing 230 may be configured to be secured to a display surface 222 with a fastener 224, such as in a threaded engagement. The housing 230 may include a transfer port 246 for communicating with a key 44 for actuating the quick-release lock mechanism 260 as explained in further detail below.

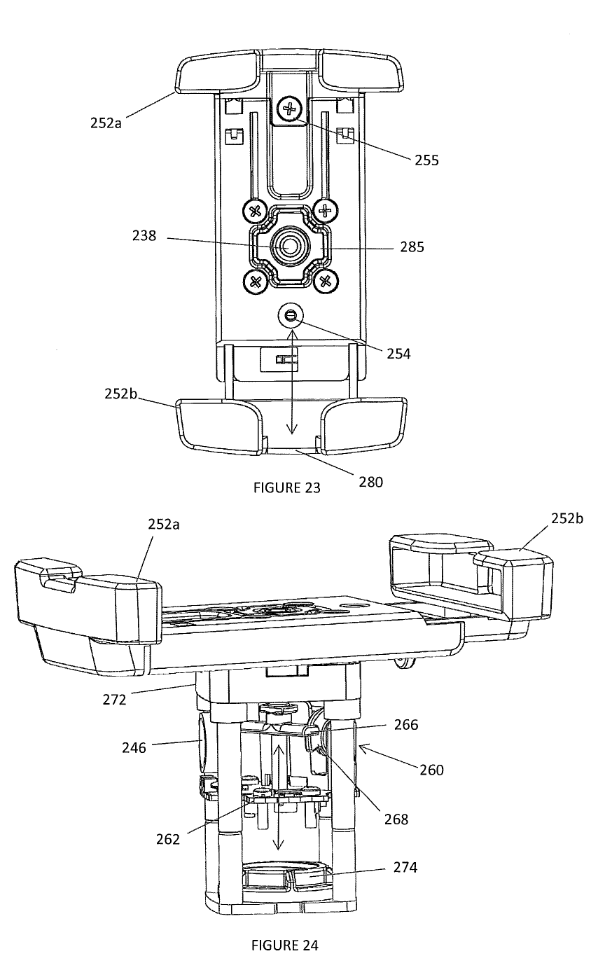

FIG. 20 shows that the bracket assembly 250 may include a pair of arms 252a, 252b. The arms 252a, 252b may oppose one another and be configured to engage opposite ends of the item of merchandise. In this embodiment, the arms 252a, 252b may be configured to engage a respective end of the item of merchandise 10 along the entire length of the end. At least one of the arms 252a, 252b may be adjustable along a longitudinal axis. For example, arm 252b may be configured to move relative to the housing 230 to adjust a distance between the end of the arm and the housing for accommodating different sized items of merchandise 10. A fastener 254 or like mechanism may be used to secure the arm 252b in position relative to the housing 230 (see, e.g., FIG. 23). The arms 252a, 252b may also be replaceable. In this regard, the arms 252a, 252b may be replaceable with different sizes for different items of merchandise 10. In the illustrated embodiment, arm 252 may be replaceable and secured with a fastener 255 or the like.

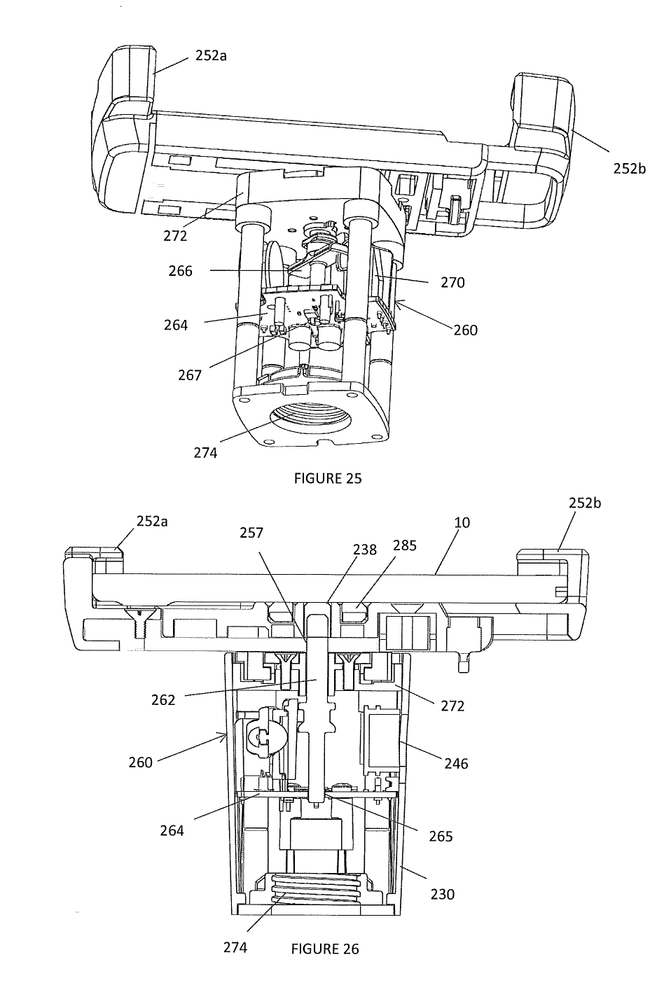

FIGS. 24-26 show the quick-release lock mechanism 260 in more detail. In FIGS. 24-25, the outer surface of the housing 230 has been removed for purposes of illustration. In this embodiment, the quick-release lock mechanism 260 includes a movable pin 262. The pin 262 is configured to engage a sensor 238. The sensor 238 may be configured to engage a rear surface of the item of merchandise 10 when the item is secured within the security device 200. In one embodiment, the sensor 238 is a pressure or plunger switch. One of the arms 252a may define a hole 257 configured to receive the pin 262 for locking the arm in position relative to the item of merchandise 10 and the housing 230. Thus, when the pin 262 is engaged within the hole 257, the arm 252a is locked in position.

An opposite end of the pin 262 is configured to operably engage a circuit board 264 disposed within the housing 230. The circuit board 264 may define a hole 265 configured to receive the pin 262 therein for engaging a switch 267. In addition, the pin 262 may include an arm 266 that is configured to engage a camming mechanism 268. The camming mechanism 268 may be operably engaged with a motor 270. Actuation of the motor 270 may rotate the camming mechanism 268 to engage the arm 266. In one example, actuation of the motor via a key 44 causes the camming mechanism to rotate and engage the arm 266 to move the pin 262 downwardly for engaging the switch 267 and disengaging hole 257 to allow the arm 252a to move to an unlocked position.

In some embodiments, the pin 262 is spring loaded or otherwise biased upwardly and towards the hole 257. Moreover, the arm 252a may be spring loaded or otherwise biased towards an unlocked configuration. Thus, when the pin 262 disengages the arm 252a, the arm is biased outwardly and out of engagement with the item of merchandise 10.

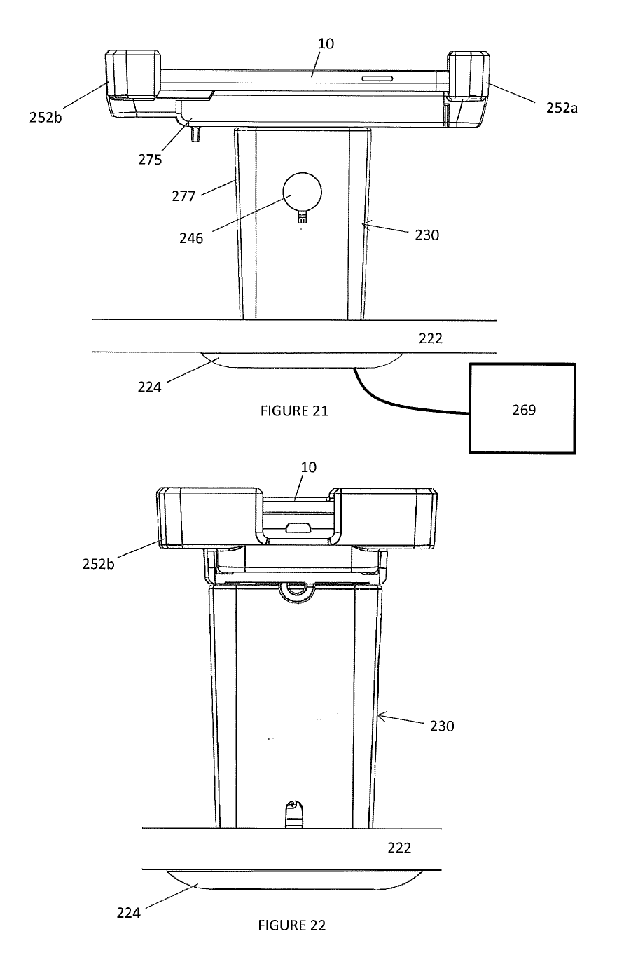

When the item of merchandise 10 is positioned on the housing 230, the item of merchandise pushes the sensor 238 downwardly towards the pin 262 thereby moving the pin downwardly and into engagement with the switch 267. Engagement of the pin 262 and the switch 267 may indicate an armed state. Thus, should the item of merchandise 10 be removed without first unlocking the quick-release lock mechanism 260 resulting in disengagement of the pin 262 with the switch 267, the alarm may generate a security signal. The pin 262 may be configured to engage the switch 267 even in an unlocked configuration. For example, when the arm 252a is unlocked and biased outwardly, the pin 262 may be configured to engage a bottom surface of the arm due to the pin no longer aligning with the hole 257. As such, the position of the pin 262 relative to the switch 267 may not change as a result of moving between locked and unlocked configurations. Therefore, the alarm may still be armed even in the unlocked configuration. In some cases, an alarm may be armed and disarmed independently of the quick-release lock mechanism 260. For example, an alarm 269 could be located remotely of the security device 200 and configured to communicate therewith (see, e.g., FIG. 21). For instance, the security device 200 may be configured to send a signal to the alarm 269 to generate a security signal when the item of merchandise is removed without first unlocking the quick-release lock mechanism 260. In this embodiment, the alarm 269 may be configured to be armed and disarmed with a key 44 independently of the locking and unlocking of the quick-release lock mechanism 260.

The quick-release lock mechanism 260 may be configured to be actuated in response to communication with a key 44, such as an electronic key. In some cases, the quick-release lock mechanism 260 is passive and does not require its own source of power for operation. Thus, the key 44 may be configured to transfer power to the quick-release lock mechanism 260 via communication with the transfer port 246. In one embodiment, the power transfer occurs via inductance. The security device 200 may include a security code, and the key 44 may only be configured to transfer power to the security device when a security code on the key matches the security code stored in the security device. In some cases, the key 44 and quick-release lock mechanism 260 are similar to that disclosed in U.S. Publication No. 2013/0081434, entitled Cabinet Lock for Use with Programmable Electronic Key, the disclosure of which is incorporated by reference in its entirety herein.

In one embodiment, the housing 230 may include a pivot assembly 272 that facilitates rotation of the item of merchandise 10 to different orientations (see, e.g., FIGS. 24-25). For example, the housing may include an upper portion 275 operably engaged with the arms 252a, 252b, and a lower portion 277 (see, e.g., FIG. 21). The upper 275 and lower 277 portions may be configured to rotate relative to one another via the pivot assembly 272. Thus, the item of merchandise 10 and arms 252a, 252b may be configured to rotate about the housing 230 (e.g., between landscape and portrait positions).

Moreover, FIGS. 24-26 show that the housing 230 may include a threaded nut 274 that is configured to threadably engage fastener 224 for securing the housing to the display surface 222. One or both of the arms 252a, 252b may also define one or more openings 280 for receiving power cords and associated connectors 40. Thus, an opening 280 may be sized and configured to receive a power cord and connector 40 for engaging an input port on the item of merchandise 10 for providing power thereto.

In one embodiment, the item of merchandise may include a back plate 285 secured to its rear surface (see, e.g., FIGS. 23 and 26). As discussed above, the back plate 285 may be used to facilitate alignment and more securely attaching the item of merchandise 10. The back plate 285 may be configured to mate with and engage a corresponding shape defined in the upper surface of the upper housing 275. The back plate 285 may thus key into the upper housing 275 and in some cases, the back plate and/or upper housing may include one or more magnets or magnetically attractable material for facilitating alignment and engagement with one another. Engagement of the back plate 285 and upper housing 275 may also prevent access to the sensor 238 thereby limiting the possibility that a potential thief can access the sensor and defeat the security device 200.

The foregoing has described one or more embodiments of a security device for securing an item of merchandise from theft or unauthorized removal. Although embodiments of the present invention have been shown and described, it will be apparent to those skilled in the art that various modifications thereto can be made without departing from the spirit and scope of the invention. Accordingly, the foregoing description is provided for the purpose of illustration only, and not for the purpose of limitation.

1. A security device for securing an item of merchandise from theft, the security device comprising:
a housing configured to be coupled to the item of merchandise; and
a quick-release lock mechanism operably engaged with the housing, the quick-release lock mechanism operable to lock the item of merchandise within or to the housing in a locked configuration and to allow the item of merchandise to be removed from the housing in an unlocked configuration,
wherein the quick-release lock mechanism is configured to communicate with an electronic key for locking and/or unlocking thereof.

2. The security device of claim 1, wherein the housing comprises a sensor configured to detect unauthorized removal of the item of merchandise from the housing.

3. The security device of claim 1, further comprising an alarm operably engaged with the housing and configured to generate a security signal in response to unauthorized removal of the item of merchandise from the housing.

4. The security device of claim 1, wherein the housing comprises a bracket assembly configured to releasably engage the item of merchandise.

5. The security device of claim 4, wherein the quick-release lock mechanism is operably engaged with the bracket assembly and is configured to release the bracket assembly from a locked configuration.

6. The security device of claim 4, wherein the bracket assembly comprises a plurality of arms configured to releasably engage the item of merchandise.

7. The security device of claim 1, further comprising a transfer port operably engaged with the lock mechanism and configured to communicate with the electronic key for locking and/or unlocking the lock mechanism.

8. The security device of claim 1, wherein the quick-release lock mechanism is configured to wirelessly communicate with the electronic key containing a security code.

9. (canceled)

10. (canceled)

11. (canceled)

12. The security device of claim 1, wherein the quick-release lock mechanism is configured to wirelessly communicate with the electronic key.

13. (canceled)

14. The security device of claim 3, wherein the quick-release lock mechanism is configured to be unlocked and the alarm is configured to be disarmed simultaneously in response to communication with the electronic key.

15. The security device of claim 1, further comprising a motor operably engaged with the quick-release lock mechanism and configured to actuate the quick-release lock mechanism in response to communication with the electronic key.

16. A method for securing an item of merchandise from theft, the method comprising:
coupling a housing to the item of merchandise;
locking the item of merchandise within or to the housing with a quick-release lock mechanism operably engaged with the housing; and
actuating the quick-release lock mechanism with an electronic key for locking and/or unlocking thereof.

17. The method of claim 16, wherein coupling comprises coupling a plurality of bracket arms to the item of merchandise.

18. (canceled)

19. The method of claim 16, further comprising actuating the electronic key.

20. The method of claim 16, wherein coupling comprises completely enclosing the item of merchandise within the housing.

21. The security device of claim 1, wherein the housing comprises a container configured to completely enclose the item of merchandise.

22. The security device of claim 21, wherein the container comprises a lid connected to a container body.

23. The security device of claim 1, further comprising a power cord electrically connected to the housing for transferring power to the item of merchandise.

24. The security device of claim 1, wherein the housing is fixed to a display surface, support, or fixture.

25. The security device of claim 1, wherein the housing comprises a clear polymeric material.
